(19) United States
(12) Patent Application Publication
(10) Pub. No.: US 2025/0190538 A1
(43) Pub. Date: Jun. 12, 2025

(54) PROXIMITY-BASED SMART DEVICE LOCKING/UNLOCKING

(71) Applicant: Dell Products L.P., Round Rock, TX (US)

(72) Inventors: Jason Bonafide, Winter Garden, FL (US); Eric L. Caron, Ottawa (CA); Eric Frank Cotter, The Woodlands, TX (US)

(21) Appl. No.: 18/623,259

(22) Filed: Apr. 1, 2024

Related U.S. Application Data
(60) Provisional application No. 63/607,383, filed on Dec. 7, 2023.

(51) Int. Cl. G06F 21/44; H04L 9/08

(52) U.S. Cl. CPC G06F 21/445; H04L 9/0872

(57) ABSTRACT

A proximity-based system for performing operations is disclosed. A device may be registered with a system configured to orchestrate proximity-based actions and then associated with other devices. A distance between a first device and a second device may be determined. The distance is used to determine whether an operation at the second device should be performed. Performing the operation is executed by generating a prompt on the first device to authorize the operation. The authorization is authenticated using cryptography or without passwords and the operation is performed at the second device when authentication is successful. This may allow a device to be unlocked/locked based on a proximity of another device associated with the original device.

### RELATED APPLICATIONS

This application claims the benefit of U.S. Provisional Application Ser. No. 63/607,383 filed Dec. 7, 2023, and entitled PROXIMITY-BASED SMART PC LOCK/UNLOCK, which application is incorporated by reference in its entirety.

### FIELD OF THE INVENTION

Embodiments of the present invention generally relate to proximity-based security systems and methods. More particularly, at least some embodiments of the invention relate to systems, hardware, software, computer-readable media, and methods for proximity-based operations including device locking operations and device unlocking operations.

### BACKGROUND

Entities (and users) are becoming increasingly reliant on their computing devices. Increased reliance on computing devices typically suggests a greater need for additional security. Implementing additional security policies often comes at the cost of convenience. Thus, entities are often looking for ways to make users and business operations more efficient and secure while reducing the burdens associated with operating computing equipment.

For example, many entities have information or data (e.g., employee data, business data, trade secrets, engineering data, company roadmaps) stored in their computing systems and there is a need to control access to and protect that data. To achieve this goal, various security measures may be implemented or required. Users, for example, are often required to provide credentials to access (e.g., unlock) their device and/or to access data stored in computing networks. Some entities may restrict users to certain devices.

Data or access may also be protected using other policies such as screen lock policies. Typically, screen lock policies are driven by time. When a computer is inactive (e.g., no user input detected) for a specified period, the computer may automatically lock. While time-based screen locking can provide some protection, this policy has associated costs. For instance, screen locking policies require users to enter their credentials each time their computer locks. This may be bothersome to the user and may cause the user to seek workarounds that defeat the policy. When longer and safer passwords are required, this may lead to the need to provide or use password managers. Balancing security policies with user convenience and user efficiency becomes a difficult task.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of providing proximity-based security and usability;

FIG. 2 discloses aspects of registering a device;

FIG. 3 discloses aspects of associating devices;

FIG. 4A discloses aspects of proximity-based policies, actuations and operations;

FIG. 4B discloses aspects of a proximity-based auto-lock security feature;

FIG. 4C discloses aspects of suspending device associations; and

FIG. 5 discloses aspects of a computing device, system, or entity.

### DETAILED DESCRIPTION OF SOME EXAMPLE EMBODIMENTS

Embodiments of the present invention generally relate to securing and/or controlling access to computing devices, computing networks, and/or data. More particularly, at least some embodiments of the invention relate to systems, hardware, software, computer-readable media, and methods for proximity-based security policies, systems and operations including, but not limited to, access operations, authentication operations, identity operations, locking/unlocking operations, or the like or combinations thereof.

Embodiments of the invention are discussed in the context of computing devices, examples of which include smart phones (phones), tablets, laptop computers, desktop computers, and the like or combinations thereof. Embodiments of the invention are also discussed in the context of FIDO (Fast Identity Online), which is an example of an open standard for authentication without passwords. However, embodiments of the invention may also use other authentication mechanisms, other device associations, and the like.

FIDO, for example, is an authentication system that includes security protocols that use public key encryption rather than passwords for enhanced authentication. FIDO (e.g., FIDO1, FIDO2) removes the requirement for passwords by using hardware keys or passkeys. Passkeys can be synchronized across many devices. Passkeys are created and associated with a user's device. When a user requires access to a device or service, they will be prompted, on their device, to enter a PIN code, provide a biometric acknowledgment or the like. This may authorize the use of a private key for example. FIDO enhances support for multiple devices (mobile, desktop, etc.) and possession-based authentication.

The World Wide Web Consortium (W3C) Web Authentication (WebAuthn) specification, as well as the FIDO Alliances, may use Client-to-Authenticator Protocol (CTAP), which is recognized as a global standard for online authentication. FIDO is discussed in more detail at https://fidoalliance.org/fido2/, which is incorporated by reference in its entirety.

In FIDO2, for example, credentials (e.g., a private key) are permanently stored on a user's device, never on a service backend server. FIDO2 may use biometric/possession-based identification (e.g., pin) to use the private key. FIDO2 may use DocAuth (identification services) instead of KBA or knowledge-based authentication (“Where did you spend your honeymoon?” etc.) as well.

FIDO2 does not use passwords and may use cross-device passkeys. FIDO2 employs APIs to enhance the overall scalability. FIDO and FIDO2 provide an authentication mechanism that does not rely on passwords, but may use physical security keys, private/public key cryptography, biometrics, platform authenticators, or the like or combinations thereof. Using FIDO and FIDO2 can eliminate or reduce the success of various types of attacks including phishing attacks.

Embodiments of the invention are also discussed in the context of UWB (Ultra-Wide Band), which is described at least in IEEE 802-15-4, IEEE 802-15-4, IEEE 802-15-4z, which are incorporated by reference in their entirety. UWB can be used in the following direct applications: Hands-Free Access Control, Location-Based Services, Device-to-Device (Peer-to-Peer) Purposes, or the like. UWB can be used for measuring distance between two devices.

As dependence on computing devices grows in terms of personal and enterprise usage, there is a desire to make interactions as efficient as possible for users. With respect to computer usage, auto screen-lock policies are used and are driven by time. While time is an adequate measure to isolate fraudulent activity to smaller windows, the use of screen-lock policies comes at a cost of constant user verification (e.g., username/password). In other words, a user may be required to enter their username/password combination multiple times during the day for various reasons including security policies such as screen locking policies. With longer and safer passwords, there becomes a need for password managers.

Embodiments of the invention are configured to improve security and usability with respect to computing devices, computing systems, computing networks, data, and the like. More specifically, embodiments of the invention relate to proximity-based actions or operations that are premised on authentication such as by way of example only FIDO.

For example, a phone may be associated with a laptop using various procedures discussed herein. Once this association is established, proximity-based rules can be used to perform various actions. For example, if the phone is detected or determined to be within a certain distance of a laptop associated with the phone, the screen of the laptop may be unlocked. Similarly, if the phone is determined to be further away from the laptop than a threshold distance, the screen of the laptop may be automatically locked. These proximity-based actions can improve security in various circumstances and eliminate the need for the user to provide a username/password combination to lock/unlock their laptop. Other device-related actions or operations could be actuated on a proximity basis. Further, proximity-based rules may also be applied to specific applications operating on a device. For example, a particular application may be executed using proximity-based rules and authentication.

Distance requirements or the distance at which actions are triggered, may vary and can be set by default, according to device location, or for other reasons. The distance requirement at a public location, such as an airport, may be less than a distance requirement at a more secure location such as at work. Further, the actions may be different based on location. Walking away from a laptop in a public area, for example, may generate a tactile or audible response, a text, or other notification in addition to locking the device.

Embodiments of the invention increase security while also enhancing usability by removing the need to input usernames/passwords in at least some circumstances.

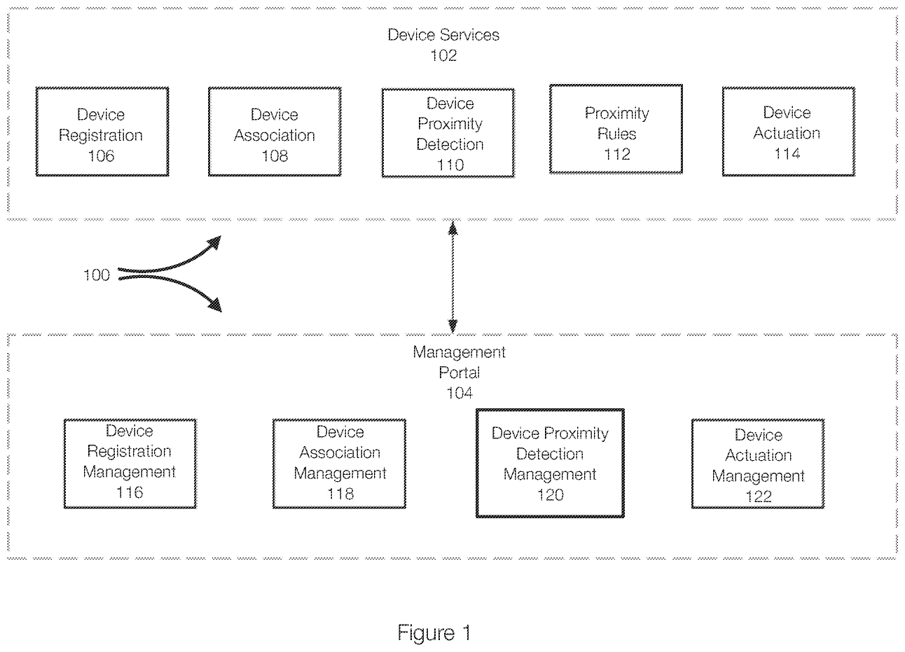

FIG. 1 discloses aspects of a proximity-based system. FIG. 1 illustrates a system 100 that include device services 102 and a management portal 104. The device services 102 and the management portal 104 may include various engines, services, or components used in providing proximity-based security or proximity-based operations. Device services 102 is generally responsible for device interactions. The management portal 104 includes or presents user interfaces (e.g., micro-service user interfaces) that aid in formulating a cohesive solution, which enables usability for the device services 102. In one example embodiment, the device services 102 may be resident on a device being protected and the management portal 104 may be cloud-based or server based.

With regard to the device services 102, device registration 106 is a service responsible for onboarding devices that will be used throughout the system 100. Device registration 106 is a service that orchestrates, in one example, key creation that is used for, by way of example only, FIDO2 authentication. Device association 108 is a service responsible for pairing devices to serve as Multi-Factor Authentication devices (e.g., phone used to authenticate a laptop). Device proximity detection 110 is a service responsible for detecting proximity between associated devices. Device proximity detection 110 may share data with or access proximity rules 112 for actuation purposes (e.g., determining whether to request an action or operation based on the distance). Proximity rules 112 is a service responsible for configuring actuation based on proximity (e.g., distance) between associated devices. Proximity rules 112 may be driven by artificial intelligence/machine learning. Device actuation 114 is a service responsible for performing or instructing operations (e.g., operations such as automatic screen lock and automatic screen unlock) on a device based on matched rules. A matched rule, in one example, is a rule that is triggered when conditions of the rule are satisfied. For example, a rule may be to perform a screen or device locking operation at a second device when a first device is further from the second device than a threshold distance.

The management portion 104 or the system 100 includes various services, engines, or components with different functions or operations. In this example, device registration management 116 is a user interface that manages and guides users in registering devices with the system 100. Device association management 118 is a user interface that manages the pairing of registered devices. Device proximity detection management 120 is a user interface that manages proximity detection rules, events, and logging. Device actuation management 122 is a user interface that manages device actuation, events, and logging. These services may be combined in various ways and may be accessed via a single portal or user interface for example.

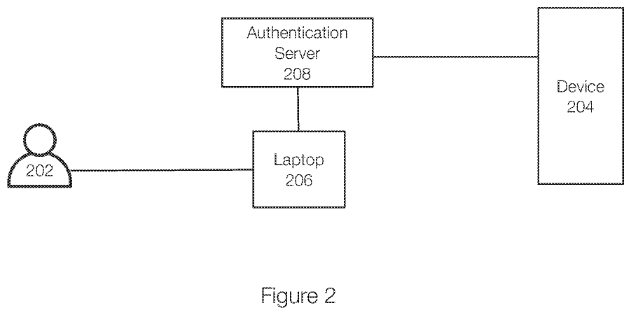

FIG. 2 generally illustrates a process of registering a device with an authentication server. Aspects of one example of device registration are disclosed in https://fidoalliance.org/fido2/and previously incorporated by reference. Thus, a device 204 (e.g., a smartphone (e.g., a laptop) associated with a user 202 may be registered with an authentication server 204 and registration information may be persisted by the authentication server 208. However, embodiments of the invention are not limited to these authentication mechanisms.

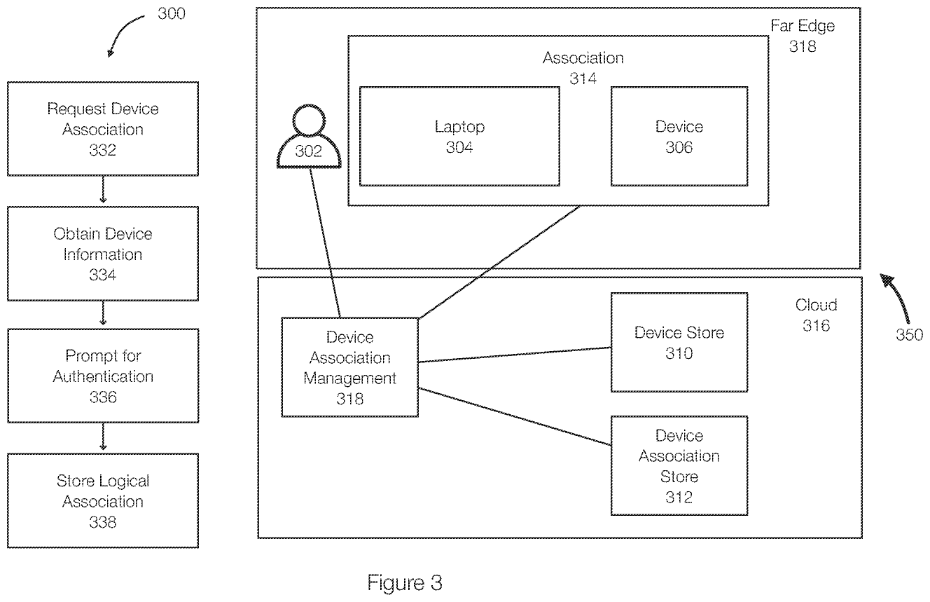

FIG. 3 discloses aspects of associating a device or associated devices with each other. FIG. 3 illustrates devices operating or using a system 350, which is an example of the system 100. FIG. 3 also illustrates an example of a method 300 for associating a first device with a second device. Once a device 306 is registered with the system 350, embodiments of the invention allow the registered device 306 to be associated with other devices such as the laptop 304.

In this example, an association 314 is generated, at the far edge 318, between the laptop 304 and the device 306 (e.g., a smartphone) 318 by interacting with a device association management server 318 (e.g., device association management 118).

In this example, a request to associate 332 the device 306 may be received at device association management 318. In response to the request, device information is obtained 334 from a device store 310. As previously stated, the device 306, which is an example of the device 228, has been registered and device information (e.g., user identifier, public key) has been stored in device store 310. Next, the device 306 is prompted for authentication. More specifically, the prompt may request a pin, a biometric, or the like in order to unlock the private key at the device 306 such that the association can be authenticated. When authenticated, the device association 314 is authorized and a logical association is stored in the device association store 312. Thus, the device 306 is associated to or with the laptop 304. Once the association 314 is established, proximity-based polices and actuate or perform proximity-based operations can be implemented and executed.

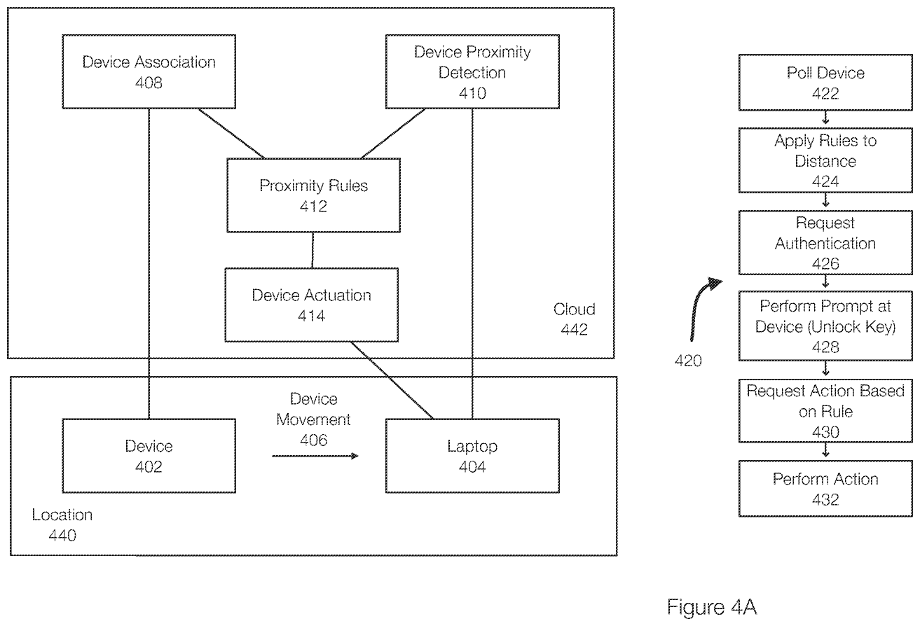

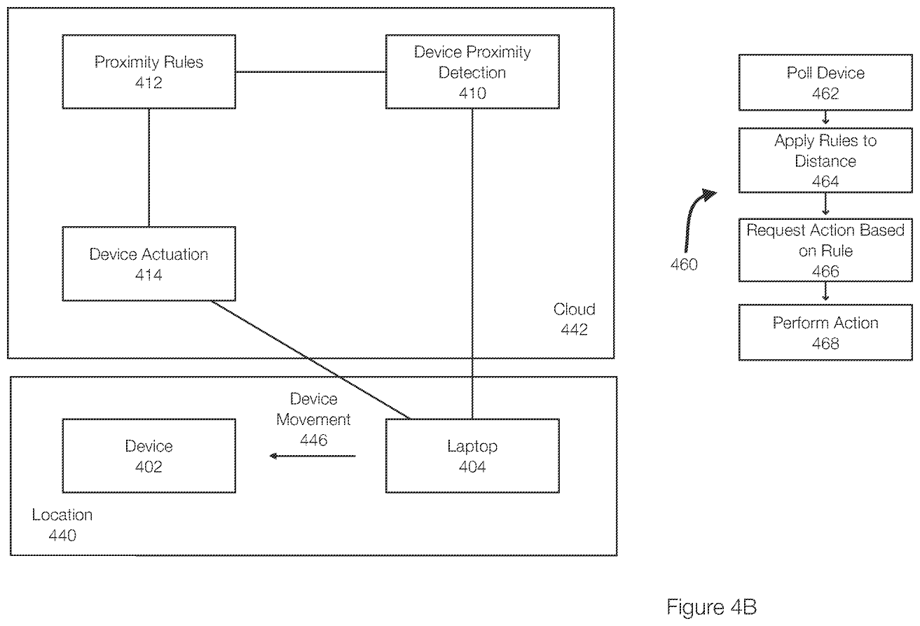

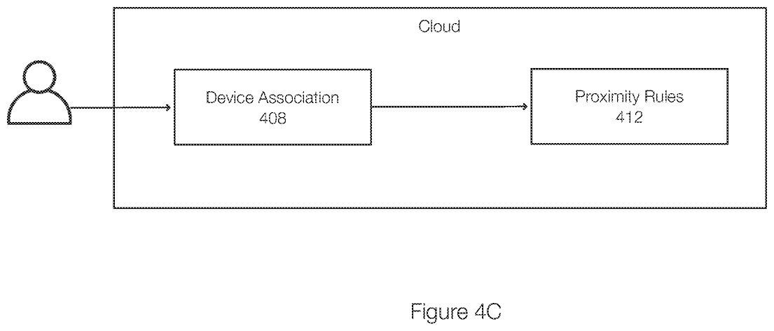

FIGS. 4A and 4B disclose aspects of proximity-based policies, actuations, and operations. FIGS. 4A and 4B are discussed in the context of authentication using private/public keys. However, other authentication mechanisms may be used. FIG. 4A more specifically discloses aspects of a proximity-based auto-unlocking feature that is implemented in the context of a system such as the system 100. In this example, the method 420 is described with reference to a UWB supported device 402 (e.g., a smartphone) that was previously registered as set forth in FIG. 2 and associated with another device (e.g., a laptop) as set forth in FIG. 3. The device movement 406 of the device 402, in this example, is towards the laptop 404. FIG. 4A further illustrates that the device 404 and the laptop 404 are at a location 440 (e.g., home, work) and that other aspects of device proximity detection and actuation may be performed in the cloud 442 in one example. Thus, FIG. 4A discloses aspects of unlocking a laptop 404 based on a proximity of the device 402 to the laptop 4094.

In the method 420, the device 402 is polled 422 using, by way of example, UWB protocols. More specifically, the proximity of the device 402 is determined by performing a polling 422 operation at the laptop 404 to determine a distance to (or position of) the device 402 relative to the laptop 404. The distance determined in this manner is provided to the device proximity detection 410 (e.g., device proximity detection 110) and to the proximity rules 412 (e.g., proximity rules 112). The proximity rules 412 applies 424 the rules to the acquired distance. In this example, a rule is matched or satisfied (e.g., device 402 is less than a threshold distance from the laptop 404 or is within a safe zone for smart unlocking). More specifically, the rule may state that the polling device or laptop 404 can be unlocked when the associated device 402 is closer than a threshold distance.

If the rule is satisfied, information associated with the device 402 is retrieved from the device association 408 (e.g., the device association 108) and used to generate an authentication prompt at the device 402. The prompt is performed 428 using the authentication strategy (e.g., fingerprint, face ID) previously configured and the private key, which is used for authentication (e.g., in FIDO2) is unlocked at the device 402. Next, device information is retrieved from the device association 408 (e.g., device association 108) and an action is requested 430 or instructed based on the rule that was matched or satisfied in the proximity rules 412. The public/private key allow the user to be authenticated such that the action being performed is authorized by the user.

The device information may be used to perform 432 the action. The device information stored at the laptop may be used to confirm the identity of the device 402 using the public and private keys or other authentication mechanism. Once the identity (and the actuation or operation to be performed) is authenticated in this manner, the operation is performed at the laptop 404. Thus, the screen of the laptop 404 is unlocked based on the proximity of the user (or device 402) to the laptop 404. Advantageously, the user is relieved of the requirement to enter a username/password combination. A prompt at the device 402, which uses facial recognition, for example, may allow the laptop 404 to be unlocked as the user walks toward the laptop 404 by merely looking at their device 402 in response to the prompt.

In one example, a laptop (or other device) may be in sleep mode and may be unable to initiate this sequence. In one example, a geo-zone may be defined with respect to the laptop. When the phone (or other device) enters the geo-zone of the laptop of last known geo-zone of the laptop, the laptop may be configured to switch to a home schedule from an away schedule. More specifically, a cloud service can wake on LAN methodology to wake the laptop to start the polling operations. Thus, the state of the laptop (e.g., asleep) can be changed, when the laptop is connected to a network, and the laptop can be unlocked in embodiments of the invention using geo-zones. In some instances, a traditional unlocking procedure may be required (e.g., after a certain period of time, in the morning).

FIG. 4B discloses aspects of a proximity-based auto-lock security feature. A method 460 relates, by way of example only, to a scenario where a user is moving out of a safe zone or further from the laptop than an allowed distance. This example also assumes that the laptop 404 and the device 402 are registered devices and associated with each other as described herein.

In the example of FIG. 4B, the device movement 446 of the device 446 is away from the laptop 404. In the method 460, the proximity of the device 402 to the laptop 404 is determined using UWB protocols (e.g., by a polling operation). As previously discussed, polling may be performed according to a schedule and rules or actions are performed only when a rule is matched. In this example, the rules may be based on a distance or are proximity-based rules.

Thus a first rule for unlocking the laptop, as described in FIG. 4A, is triggered when a distance between the device 402 and the laptop 404 is less than a threshold distance. A different or second rule for locking the laptop 404 is triggered when a distance between the device 402 and the laptop 404 is greater than a threshold distance. The thresholds for different rules may be different.

In FIG. 4B, the distance between the device 402 and the laptop 404 is determined by a polling 462 operation performed at the laptop 404. The distance may be acquired or received by a device proximity detection 410, which may provide the distance to the proximity rules 412. In this example, the rules are applied 464 to the distance and a rule is matched (an auto-locking rule). Thus, the the device 402 is outside of the safe-zone (e.g., in which smart unlocking may be performed as previously described). In this example an action based on the rule is requested 466 and the action is performed 468. Thus, the laptop screen is locked because the device 402 is outside of a safe zone or further away from the laptop 404 than a threshold distance. Because locking and unlocking are different, a prompt may not be required to lock the device. This may be configured via a portal or user interface.

FIG. 4C discloses aspects of suspending device associations. In some examples, it may be necessary to suspend the operation of the rules and corresponding actions. In FIG. 4C, a user may submit a request for disassociation. Using the example of FIGS. 4A and 4B, the user may request that the device 402 and the laptop 404 be disassociated if the device 402 is lost. This may be performed from the laptop 404. In another example, the request for disassociation (and other actions) may be performed via a portal from another device.

In this example, the disassociation request may be received by the device association 408. In a disassociation method, a cascading delete then propagates through the proximity rules 412 to delete rules that are dependent on the relationship between the device 402 and the 404. Existing rule priority may proceed normally.

In another example, the user may leave their device 402 next to their laptop 404. In this example, a person moving away from their laptop would not be detected and the proximity based locking operation or auto-lock feature would not be invoked. In this example, embodiments of the invention may be supplemented with time-based rules such that the screen is locked when no activity is detected within a time limit. In one example, the screen may lock in accordance with conventional screen lock protocols of the device.

Embodiments of the invention may relate to a service (e.g., DELL APEX service) that provides or implements a system such as the system 100. Embodiments of the invention use accurate location tracking or position or distance determinations (e.g., using UWB) to provide additional layers of security while improving usability. The foregoing examples illustrate that the distance between a phone and a laptop (or between 2 or more associated devices) may be used to perform various operations or implement security policies such as locking and/or unlocking. This allows a user's laptop to be unlocked without a password and allows the user to leave the laptop without having to actively lock the laptop. This protects the laptop from malicious use by others in one example. The rules can be set, for example, such that the security rules are performed when the distance is quite small. For instance, a laptop may be locked automatically even when within view of the user.

Further, polling may be performed on a schedule that may account for situations where a user performs an unexpected action. For example, a laptop may be unlocked when the user is coming towards the device. If the user suddenly turns around and leaves the safe-zone, polling with a sufficient frequency will detect this type of situation and lock the device.

Embodiments of the invention allow IT policies to be applied. For example, smart auto locking and/or auto unlocking polices can be implemented based on device-proximity data. Rather than relying on timers, which do not necessarily determine whether a user is near their device, embodiments may use consented location data as an added measure for laptop or device security. Embodiments of the invention can be used alongside other/existing means of security including when applied to corporate laptops, other devices, applications, and information including sensitive information.

Embodiments of the invention can be applied as a set of proximity-based rules that can be applied to different groups or different security-level policies. For example, the rules for one group may be different from the rules for another group. Screens may be locked for one group dealing with sensitive information when the user is still quite close to their device. The threshold distance may be different for groups that are not dealing with sensitive information and do not have access to sensitive information. One goal is to balance security with usability, sensitivity, practicality, and the like. In some examples, unlocking through proximity detection may be disabled (e.g., teams with high clearance levels). In addition, locking may have a very small distance threshold in some instances (e.g., sensitive data, high clearance levels).

Embodiments of the invention thus relate to proximity authentication that, in one example, is based on UWB and FIDO2. However, other wireless communications or authentication protocols may be included or used. More specifically, proximity location between two UWB supported device may be used to automatically authenticate. This may be driven by proximity polling and a rules engine that enables flexibility.

Proximity detection and device actuation based on UWB allows various actions to be orchestrated by a system that in a rules based manner. Embodiments of the invention may also relate to a machine learning based system that is trained based on historical device usage and user locations and actions. Thus, decisions of whether to lock or unlock a device may be proximity based using machine learning.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations which may include, but are not limited to, authentication operations, distance determining operations, polling operations, passkey operations, security related operations, device operations including locking/unlocking operations, application operations, or the like. More generally, the scope of the invention embraces any operating environment in which the disclosed concepts may be useful.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

Example embodiments of the invention are applicable to any system capable of storing and handling various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.
Embodiment 1. A method comprising determining a distance between a first device and a second device, wherein the first device is registered with a system configured to orchestrate proximity-based operations and wherein the first device is associated with the second device in the system, applying the distance to a set of rules, requesting authentication from the first device, and performing an action associated with a rule in the set of rules that is triggered by the distance at the second device after performing authentication.
Embodiment 2. The method of embodiment 1, further comprising determining a geo-zone for the second device and waking the second device when the first device enters the geo-zone such that the distance can be determined.
Embodiment 3. The method of embodiment 1 and/or 2, wherein operations and configurations related to performing the action are configured to be set or changed at least via an online portal or via the first device or via the second device.
Embodiment 4. The method of embodiment 1, 2, and/or 3, further comprising requesting that the first device be associated with the second device.
Embodiment 5. The method of embodiment 1, 2, 3, and/or 4, further comprising obtaining information about the first device and generating a prompt at the first device for authentication in order to authorize associating the first device with the second device, wherein the prompt is used to unlock the private key for the authentication.
Embodiment 6. The method of embodiment 1, 2, 3, 4, and/or 5, further comprising storing the association between the first device and the second device in a device association storage, wherein the device association storage is cloud based.
Embodiment 7. The method of embodiment 1, 2, 3, 4, 5, and/or 6, further comprising polling the first device according to a schedule.
Embodiment 8. The method of embodiment 1, 2, 3, 4, 5, 6, and/or 7, further comprising determining the distance based on the polling, wherein the polling is performed using UWB (Ultra-Wideband) protocols.
Embodiment 9. The method of embodiment 1, 2, 3, 4, 5, 6, 7, and/or 8, wherein the action is locking the second device when the distance is greater than a threshold distance and wherein the action is unlocking the second device when the distance is less than the threshold distance.
Embodiment 10. The method of embodiment 1, 2, 3, 4, 5, 6, 7, 8, and/or 9, wherein the threshold distance depends on a location of the first device and of the second device.
Embodiment 11. The method of embodiment 1, 2, 3, 4, 5, 6, 7, 8, 9, and/or 10, wherein the authentication is passkey authentication using cryptography.
Embodiment 12. The method of embodiment 1, 2, 3, 4, 5, 6, 7, 8, 9, 10, and/or 11, wherein the authentication includes unlocking a private key at the first device using a personal identification number (PIN), a fingerprint, facial recognition, or other method.
Embodiment 13. The method of embodiment 1, 2, 3, 4, 5, 6, 7, 8, 9, 10, 11, and/or 12, further comprising registering a first device with a system configured to orchestrate proximity-based operations and associating the first device with the second device.
Embodiment 14. A system, comprising hardware and/or software, operable to perform any of the operations, methods, or processes, or any portion of any of these, disclosed herein.
Embodiment 15. A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

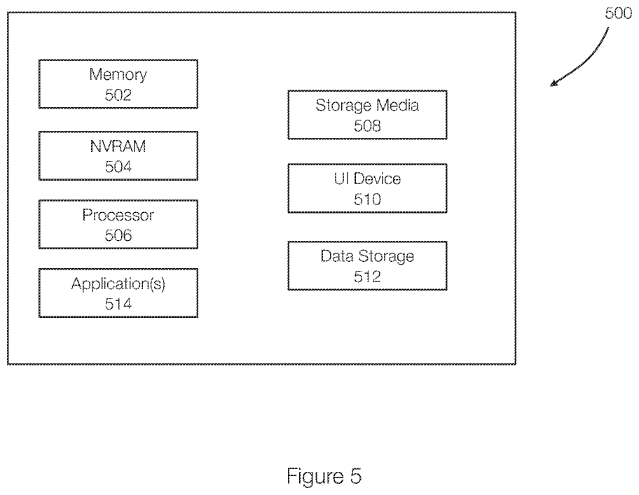

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also be representative of a containerized environment with multiple hosts, servers, storage, and other infrastructure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining a distance between a first device and a second device, wherein the first device is registered with a system configured to orchestrate proximity-based operations and wherein the first device is associated with the second device in the system;
applying the distance to a set of rules;
requesting authentication from the first device; and
performing an action associated with a rule in the set of rules that is triggered by the distance at the second device after performing authentication.

2. The method of claim 1, further comprising:
determining a geo-zone for the second device and waking the second device when the first device enters the geo-zone such that the distance can be determined.

3. The method of claim 1,
wherein operations and configurations related to performing the action are configured to be set or changed at least via an online portal or via the first device or via the second device.

4. The method of claim 1, further comprising requesting that the first device be associated with the second device.

5. The method of claim 4, further comprising obtaining information about the first device and generating a prompt at the first device for authentication in order to authorize associating the first device with the second device, wherein the prompt is used to unlock the private key for the authentication.

6. The method of claim 5, further comprising storing the association between the first device and the second device in a device association storage, wherein the device association storage is cloud based.

7. The method of claim 1, further comprising polling the first device according to a schedule.

8. The method of claim 7, further comprising determining the distance based on the polling, wherein the polling is performed using UWB (Ultra-Wideband) protocols.

9. The method of claim 8, wherein the action is locking the second device when the distance is greater than a threshold distance and wherein the action is unlocking the second device when the distance is less than the threshold distance.

10. The method of claim 9, wherein the threshold distance depends on a location of the first device and of the second device.

11. The method of claim 1, wherein the authentication is passkey authentication using cryptography.

12. The method of claim 1, wherein the authentication includes unlocking a private key at the first device using a personal identification number (PIN), a fingerprint, facial recognition, or other method.

13. The method of claim 1, further comprising registering a first device with a system configured to orchestrate proximity-based operations and associating the first device with the second device.

14. A non-transitory storage medium having stored therein instructions that are executable by one or more hardware processors to perform a method comprising:
determining a distance between a first device and a second device, wherein the first device is registered with a system configured to orchestrate proximity-based operations and wherein the first device is associated with the second device in the system;
applying the distance to a set of rules;
requesting authentication from the first device; and
performing an action associated with a rule in the set of rules that is triggered by the distance at the second device after performing authentication.

15. The non-transitory storage medium of claim 14, further comprising:
determining a geo-zone for the second device and waking the second device when the first device enters the geo-zone such that the distance can be determined.

16. The non-transitory storage medium of claim 14, further comprising:
obtaining information about the first device and generating a prompt at the first device for authentication in order to authorize associating the first device with the second device, wherein the prompt is used to unlock the private key for the authentication; and
storing the association between the first device and the second device in a device association storage, wherein the device associated storage is cloud based, wherein operations and configurations related to performing the action are configured to be set or changed at least via an online portal or via the first device or via the second device.

17. The non-transitory storage medium of claim 14, further comprising polling the first device according to a schedule and determining the distance based on the polling, wherein the polling is performed using UWB (Ultra-Wideband) protocols.

18. The non-transitory storage medium of claim 14, wherein the action is locking the second device when the distance is greater than a threshold distance and wherein the action is unlocking the second device when the distance is less than the threshold distance.

19. The non-transitory storage medium of claim 18, wherein the threshold distance depends on a location of the first device and of the second device and wherein the authentication is passkey authentication using cryptography.

20. The non-transitory storage medium of claim 14, wherein the authentication includes unlocking a private key at the first device using a pin, a fingerprint, facial recognition, or other method, further comprising registering a first device with a system configured to orchestrate proximity-based operations and associating the first device with the second device.
